(19) United States
(12) Patent Application Publication
(10) Pub. No.: US 2026/0196083 A1
(43) Pub. Date: Jul. 9, 2026

(54) PRE-INCIDENT DATA SNAPSHOT

(71) Applicant: Ford Global Technologies, LLC, Dearborn, MI (US)

(72) Inventors: Keith Weston, Canton, MI (US); Stuart C. Salter, White Lake, MI (US); Brendan F. Diamond, Naples, FL (US); John Robert Van Wiemeersch, Novi, MI (US); Anthony Maraldo, Southgate, MI (US); Andrew Brown, Royal Oak, MI (US)

(21) Appl. No.: 19/014,891

(22) Filed: Jan. 9, 2025

(51) Int. Cl. G07C 5/00; G06F 11/1446; G06F 3/04847; G06V 10/70; G06V 20/56

(52) U.S. Cl. CPC G07C 5/008; G06F 11/1451; G06F 3/04847; G06F 2201/84; G06V 10/70; G06V 20/56

(57) ABSTRACT

A likelihood score is determined by a vehicle that is indicative of a probability of an incident based on real-time sensor data. Responsive to the likelihood score meeting a predefined threshold, a data snapshot is generated comprising vehicle data, global navigation satellite system (GNSS) location data, and occupant information, wherein the data snapshot defines an expiration after which the data snapshot is to be automatically deleted. The data snapshot is transmitted to a cloud server for temporary storage at the cloud server and automatic deletion based on the expiration.

### TECHNICAL FIELD

Aspects of the disclosure generally relate to detecting and addressing situations where the vehicle may be unable to provide data, by sending a pre-incident data snapshot from the vehicle.

### BACKGROUND

Connected vehicles may send data to a cloud system. In other examples, a telematics control unit (TCU) of the vehicle may collect the vehicle operating data and send the data to the remote server for analysis.

### SUMMARY

In one or more illustrative examples, a method for sending vehicle data includes determining, by a vehicle, a likelihood score indicative of a probability of an incident based on real-time sensor data; responsive to the likelihood score meeting a predefined threshold, generating a data snapshot comprising vehicle data, global navigation satellite system (GNSS) location data, and occupant information, wherein the data snapshot defines an expiration after which the data snapshot is to be automatically deleted; and transmitting the data snapshot to a cloud server for temporary storage at the cloud server and automatic deletion based on the expiration.

In one or more illustrative examples, the method further includes responsive to determining that the incident does not occur, sending a cancel hold message to the cloud server to cause the cloud server to refrain from forwarding the data snapshot to a dispatch service and delete the data snapshot before the expiration.

In one or more illustrative examples, the data snapshot is sent to the cloud server (i) via a telematics control unit (TCU) of the vehicle over a communication network or (ii) via an occupant mobile device responsive to the TCU being unable to access the communication network.

In one or more illustrative examples, the data snapshot further comprises permissions specifying access restrictions for third-party requester devices to the data snapshot.

In one or more illustrative examples, the method further includes utilizing a human-machine interface (HMI) of the vehicle to present a configuration interface for users to opt into enabling generation of the data snapshot and for the users to define which elements of vehicle data and occupant information to be included in the snapshot; and updating user settings for generation of the data snapshot responsive to user input to the HMI.

In one or more illustrative examples, determining the likelihood score includes analyzing the sensor data, from radio detection and ranging (RADAR), light detection and ranging (LIDAR), ultrasonic systems, and/or cameras of the vehicle; integrating map data indicating roadway hazards or geographic features; and applying a machine learning model trained on the sensor data to assess the probability of the incident.

In one or more illustrative examples, the expiration specifies one of a date and/or time after which the data snapshot is deleted, or a time-to-live of the data snapshot after which the data snapshot is deleted.

In one or more illustrative examples, a vehicle for sending vehicle data includes sensors; and one or more controllers configured to determine, by a vehicle, a likelihood score indicative of a probability of an incident based on real-time sensor data, responsive to the likelihood score meeting a predefined threshold, generate a data snapshot comprising one or more of GNSS location data, occupant information, and vehicle data captured by the sensors, wherein the data snapshot defines an expiration after which the data snapshot is to be automatically deleted, and transmit the data snapshot to a cloud server for temporary storage at the cloud server and automatic deletion based on the expiration.

In one or more illustrative examples, the one or more controllers are further configured to, responsive to determining that the incident does not occur, send a cancel hold message to the cloud server to cause the cloud server to refrain from forwarding the data snapshot to a dispatch service and delete the data snapshot before the expiration.

In one or more illustrative examples, the one or more controllers are further configured to send the data snapshot to the cloud server (i) via a TCU of the vehicle over a communication network or (ii) via an occupant mobile device responsive to the TCU being unable to access the communication network.

In one or more illustrative examples, the data snapshot further comprises permissions specifying access restrictions for third-party requester devices to the data snapshot.

In one or more illustrative examples, the one or more controllers are further configured to utilize a HMI of the vehicle to present a configuration interface for users to opt into enabling generation of the data snapshot and for the users to define which elements of vehicle data and occupant information to be included in the snapshot; and update user settings for generation of the data snapshot responsive to user input to the HMI.

In one or more illustrative examples, the one or more controllers are further configured to determine the likelihood score using operations including to analyze the sensor data, from RADAR, LIDAR, ultrasonic systems, and/or cameras of the vehicle; integrate map data indicating roadway hazards or geographic features; and apply a machine learning model trained on the sensor data to assess the probability of the incident.

In one or more illustrative examples, the expiration specifies one of a date and/or time after which the data snapshot is deleted, or a time-to-live of the data snapshot after which the data snapshot is deleted.

In one or more illustrative examples, a cloud server for managing data snapshots includes a database; and one or more computing devices configured to receive a data snapshot transmitted from a vehicle or an occupant mobile device over a communication network, wherein the data snapshot includes vehicle data from sensors of the vehicle, wherein the data snapshot defines an expiration after which the data snapshot is to be automatically deleted and a unique identifier of the vehicle, store the data snapshot in the database, indexed by the unique identifier, responsive to receiving a request from a third-party requester device, validate the request against access permissions associated with the data snapshot and transmit the data snapshot to the third-party requester device if the request is authorized, responsive to lack of receipt of a cancel hold message from the vehicle within a predefined period of time within the expiration, automatically forward the data snapshot to a dispatch service, and automatically delete the data snapshot from the database based on the expiration.

In one or more illustrative examples, the one or more computing devices are further configured to automatically delete the data snapshot from the database responsive to receipt of the cancel hold message from the vehicle.

In one or more illustrative examples, the unique identifier includes one or more of a vehicle identification number (VIN), a barcode, or a license plate number.

In one or more illustrative examples, the data snapshot further includes GNSS location data indicative of a history of locations of the vehicle.

In one or more illustrative examples, the data snapshot further includes occupant information indicative of identifies of one or more occupants of the vehicle.

In one or more illustrative examples, wherein the expiration specifies one of a date and/or time after which the data snapshot is deleted, or a time-to-live of the data snapshot after which the data snapshot is deleted.

### BRIEF DESCRIPTION OF THE DRAWINGS

FIG. 1 illustrates an example system for sending a pre-incident data snapshot from the vehicle;

FIG. 2 illustrates a data flow for assessing a likelihood score indicative of a probability of occurrence of an incident;

FIG. 3 illustrates an example of a data snapshot generated based on the likelihood score;

FIG. 4 illustrates an example configuration screen for the configuration of the user settings for generation of the data snapshot;

FIG. 5 illustrates an example process for the generation of data snapshots by the vehicle;

FIG. 6 illustrates an example process for the receipt, distribution, and deletion of data snapshots by cloud server; and

FIG. 7 illustrates an example computing device for use in sending a pre-incident data snapshot from the vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A vehicle may include various controllers, sensors, and networked functionality. In some cases, one or more of those controllers or sensors may malfunction or become damaged. In such an occurrence, vehicle functionality may be reduced. In particular, access to useful vehicle information may be lost.

The vehicle may be configured to use sensors, such as radio detection and ranging (RADAR), light detection and ranging (LIDAR), ultrasonic, and cameras, to assess a probability of such an incident by monitoring environmental factors, relative velocities, and trajectories. When the likelihood of an incident exceeds a calibrated threshold, the incident may capture a data snapshot. The contents of the data snapshot may include including global navigation satellite system (GNSS) location, vehicle status, and occupant information, and may be configurable by the user. This data snapshot may be encrypted and sent to a cloud server. The data snapshot may automatically expire and delete to ensure that any sensitive information is not retained by the cloud server, ensuring user privacy.

In some examples, the data snapshot may be requested by third-party requesters, such as by service vehicle operators. This may allow personnel arriving to the aid of the vehicle to be able to access the data snapshot. In other examples, the data snapshot may be proactively provided by the cloud server to a dispatcher. For example, if the vehicle does not cancel the data snapshot within a predefined time period (e.g., three minutes), the cloud server may send the data snapshot to a designated party such as to a dispatch call center. In some cases, the cloud server may check with vehicle and/or with the occupant devices to confirm that the data snapshot should be sent.

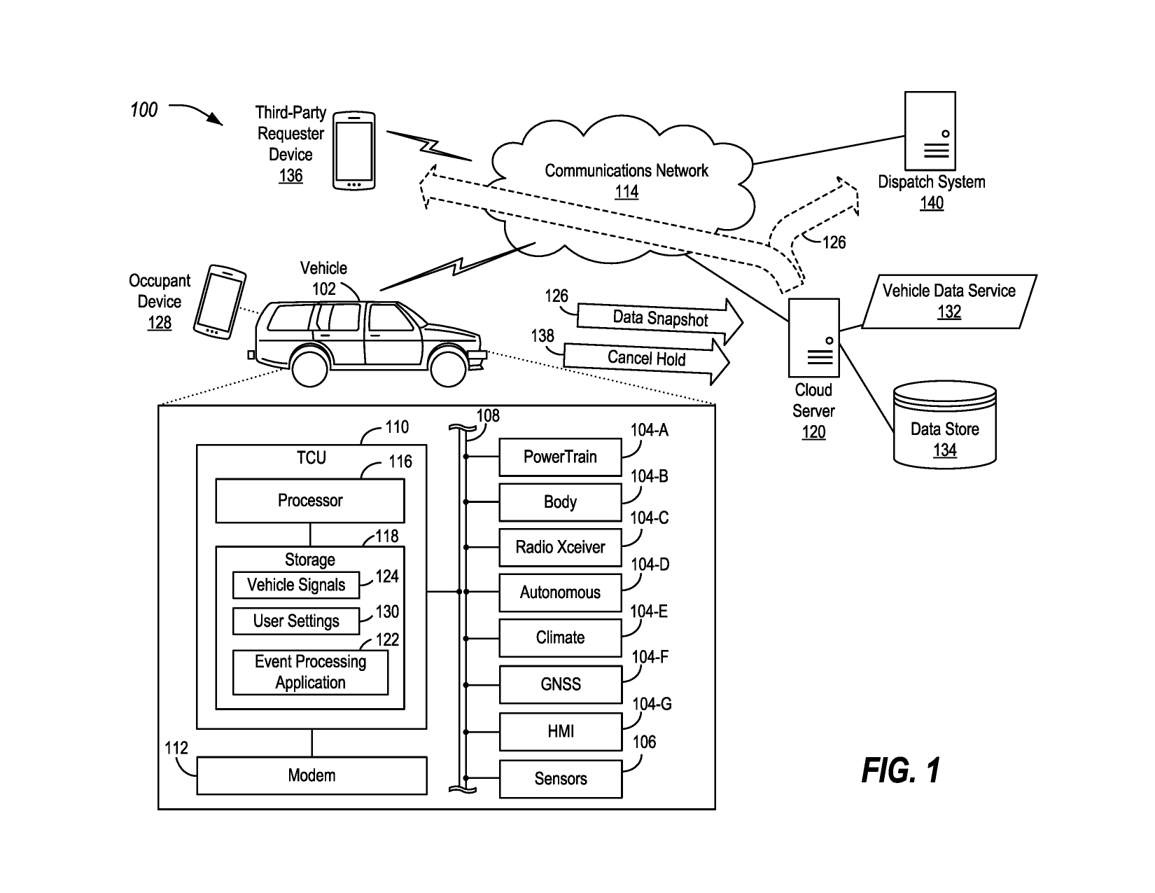

FIG. 1 illustrates an example system 100 for sending a pre-incident data snapshot 126 from the vehicle 102. The system 100 includes one or more vehicles 102, where each vehicle 102 includes a plurality of controllers 104 and sensors 106. Each vehicle 102 also includes one or more vehicle buses 108 for communication between the controller 104, sensors 106, and a TCU 110. The TCU 110 includes or otherwise has access to a modem 112 configured to facilitate communication over a communication network 114. The TCU 110 may include a processor 116 and a storage 118. The TCU 110 may capture vehicle signals 124 and maintain them in the storage 118. The storage 118 may also maintain an event processing application 122. The event processing application 122 may compile the vehicle signals 124 into a data snapshot 126 and may send the data snapshot 126 to a cloud server 120 or other destination. The data snapshot 126 may then be accessible, via a vehicle data service 134 of the cloud server 120, by a third-party requester device 136, should the need arise, regardless of whether the vehicle 102 continues to be able to transmit data. The TCU 110 may, in other examples, use an occupant mobile device 128 to transmit the data snapshot 126 to the cloud server 120 in a case where the TCU 110 loses access to the communication network 114. It should be noted that the system 100 is only an example, and systems 100 with more, fewer, or different components may be used.

The vehicle 102 may be any various types of automobile, crossover utility vehicle (CUV), sport utility vehicle (SUV), truck, recreational vehicle, boat, plane or other mobile machine for transporting people or goods. Such vehicles 102 may be human-driven or autonomous. In many cases, the vehicle 102 may be powered by an engine. As another possibility, the vehicle 102 may be a battery electric vehicle powered by one or more electric motors. As a further possibility, the vehicle 102 may be a hybrid electric vehicle powered by both an engine and one or more electric motors, such as a series hybrid electric vehicle, a parallel hybrid electrical vehicle, a parallel/series hybrid electric vehicle, and/or a plug-in hybrid electric vehicle. Alternatively, the vehicle 102 may be an autonomous vehicle (AV). The level of automation may vary between variant levels of driver assistance technology to a fully automatic, driverless vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs). It should be noted that while automotive vehicles 102 are being used as examples of traffic participants, other types of traffic participants may additionally or alternately be used, such as bicycles, scooters, and pedestrians.

The vehicle 102 may include a plurality of controllers 104 configured to perform and manage various vehicle 102 functions under the power of the vehicle battery and/or drivetrain. As depicted, the example vehicle controllers 104 are represented as discrete controllers 104 (i.e., controllers 104A through 104G). However, the vehicle controllers 104 may share physical hardware, firmware, and/or software, such that the functionality from multiple controllers 104 may be integrated into a single controller 104, and that the functionality of various such controllers 104 may be distributed across a plurality of controllers 104.

As some non-limiting vehicle controller 104 examples: a powertrain controller 104A may be configured to provide control of engine operating components (e.g., idle control components, fuel delivery components, emissions control components, etc.) and for monitoring status of such engine operating components (e.g., status of engine codes); a body controller 104B may be configured to manage various power control functions such as exterior lighting, interior lighting, keyless entry, remote start, and point of access status verification (e.g., closure status of the hood, doors and/or trunk of the vehicle 102); a radio transceiver controller 104C may be configured to communicate with key fobs, mobile devices, or other local vehicle 102 devices; an autonomous controller 104D may be configured to provide commands to control the powertrain, steering, or other aspects of the vehicle 102; a climate control management controller 104E may be configured to provide control of heating and cooling system components (e.g., compressor clutch, blower fan, temperature sensors, etc.); a GNSS controller 104F may be configured to provide vehicle location information; and a human-machine interface (HMI) controller 104G may be configured to receive user input via various buttons or other controls, as well as provide vehicle status information to a driver, such as fuel level information, engine operating temperature information, and current location of the vehicle 102.

The controllers 104 of the vehicle 102 may make use of various sensors 106 in order to receive information with respect to the surroundings of the vehicle 102. In an example, these sensors 106 may include one or more of cameras (e.g., advanced driver-assistance system (ADAS) cameras), ultrasonic sensors, radar systems, and/or lidar systems.

One or more vehicle buses 108 may include various methods of communication available between the vehicle controllers 104, as well as between the TCU 110 and the vehicle controllers 104. As some non-limiting examples, the vehicle bus 108 may include one or more of a vehicle controller area network (CAN), an Ethernet network, and a media-oriented system transfer (MOST) network, or a wireless bus.

The TCU 110 may include network hardware configured to facilitate communication between the vehicle controllers 104 and with other devices of the system 100. For example, the TCU 110 may include or otherwise access a modem 112 configured to facilitate communication over a communication network 114. The TCU 110 may, accordingly, be configured to communicate over various protocols, such as with the communication network 114 over a network protocol (such as Uu). The TCU 110 may, additionally, be configured to communicate over a broadcast peer-to-peer protocol (such as PC5), to facilitate cellular vehicle-to-everything (C-V2X) communications with devices such as other vehicles 102. It should be noted that these protocols are merely examples, and different peer-to-peer and/or cellular technologies may be used.

The TCU 110 may include various types of computing apparatus in support of performance of the functions of the TCU 110 described herein. In an example, the TCU 110 may include one or more processors 116 configured to execute computer instructions, and a storage 118 medium on which the computer-executable instructions and/or data may be maintained. A computer-readable storage medium (also referred to as a processor-readable medium or storage 118) includes any non-transitory (e.g., tangible) medium that participates in providing data (e.g., instructions) that may be read by a computer (e.g., by the processor(s) 116). In general, the processor 116 receives instructions and/or data, e.g., from the storage 118, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, JavaScript, Perl, etc.

The TCU 110 may be configured to include one or more interfaces from which information of the vehicle 102 may be sent and received. This information can be sensed, recorded, and sent to one or more cloud servers 120. In an example, similar to the TCU 110, the cloud server 120 may also include one or more processors (not shown) configured to execute computer instructions, and a storage medium (not shown) on which the computer-executable instructions and/or data may be maintained.

The event processing application 122 may be an application installed to the TCU 110 for use in performing one or more of the operations of the TCU 110 as discussed in detail herein. In an example, the management of the vehicle signals 124, data snapshots 126, etc., may be handled by an event processing application 122 executed by the TCU 110.

The event processing application 122 may be configured to facilitate the collection of vehicle signals 124 from the vehicle controllers 104 connected to the one or more vehicle buses 108. These may include, for example, ADAS vehicle signals 124 generated by ADAS functions of the vehicle 102. While only a single vehicle bus 108 is illustrated, it should be noted that in many examples, multiple vehicle buses 108 are included, usually with a subset of the controllers 104 connected to each vehicle bus 108. Accordingly, to access a given controller 104, the TCU 110 may be configured to maintain a mapping of which vehicle buses 108 are connected to which controllers 104, and to access the corresponding vehicle bus 108 for a controller 104 when communication with that particular controller 104 is desired.

The event processing application 122 may be further configured to utilize the vehicle signals 124 from the sensors 106 to assess a probability of occurrence of an incident where one or more of those controllers 104 or sensors 106 may malfunction or become damaged. This may be accomplished, for example, by monitoring environmental factors, relative velocities, and trajectories. Responsive to the likelihood of an incident exceeding a calibrated threshold, the incident may capture a data snapshot 126, including GNSS location (e.g., as determined by the GNSS controller 104F), vehicle status, and occupant information. The contents of the data snapshot 126 may be configurable by the user. This data snapshot 126 may be encrypted and sent to the cloud server 120. If the incident does not occur within a defined time, the data snapshot 126 may automatically expire and delete.

As used herein, vehicle signals 124 (e.g., ADAS signals and the like) may refer to various binary, multi-state, integer, float, and/or continuous parameters that may be generated or otherwise raised by the vehicle controller 104 and/or sensors 106. The vehicle signals 124 may include varying unit types, such as time series data of differing frequency and event streams, and/or differing object types such as float, array, matrices, nested data types, etc. As some non-limiting examples, the vehicle signals 124 may include one or more of: latitude, longitude, time, heading angle, speed, throttle position, brake status, steering angle, headlight status, wiper status, external temperature, turn signal status, ambient temperature or other weather conditions, alertness status, hands-off-wheel status, all-wheel drive (AWD) engaged status, front object detection, side object detection status, rear object detection status, etc.

In some examples, the vehicle signals 124 may further include information regarding the identities and other aspects of occupants of the vehicle 102. This information may be maintained by the vehicle 102, and/or may be requested from occupant mobile devices 128 when a data snapshot 126 is to be created. The occupant mobile devices 128 may refer to phones, tablets, smartwatches, wearables, laptops, music players, etc., that are associated with specific users and that are configured to provide information indicative of the identities of those specific users.

The event processing application 122 may utilize user settings 130 to determine which data to include in the data snapshot 126. As the data snapshot 126 feature is opt-in, the user may be required to expressly enable the creation and sending of the data snapshot 126. In an example, the vehicle 102 may utilize an HMI to provide an opt-in agreement for the transfer of data. In many examples, the HMI may also allow for the user to adjust configurable settings to allow the data snapshots 126 to only include the data that the customer agrees to transmit.

The cloud server 120 refers to one or more hardware devices configured to communicate with the vehicles 102 over the communication network 114. The cloud server 120 may include or otherwise have access to a database 132 that can be used to store information, such as any data snapshots 126 that are received from the vehicles 102.

The vehicle data service 134 may be an application installed to the cloud server 120 for use in performing one or more of the operations of the cloud server 120 as discussed in detail herein. In an example, the storage, access, and automatic deletion of the data snapshots 126, etc., may be handled by the vehicle data service 134.

The one or more third-party requester devices 136 may be configured to access the cloud server 120 over the communication network 114. Using the services of the vehicle data service 134 of the cloud server 120, the one or more third-party requester devices 136 may be configured to access the data snapshot 126 of the vehicles 102. In an example, the third-party requester devices 136 may be operated by assistance personnel giving aid to occupants of a vehicle 102 that has become disabled. Because the data snapshot 126 can be retrieved from the cloud server 120, the data included in the data snapshot 126, such as GNSS location, vehicle status, operation history, and occupant information, may continue to be available despite the vehicle 102 no longer being able to provide the data directly.

If the incident does not occur, the event processing application 122 may be configured to send a cancel hold message 138 to the cloud server 120. The cancel hold message 138 may be sent from the vehicle 102 to the cloud server 120, to inform the cloud server 120 that the data snapshot 126 is not required. Responsive to receipt of the cancel hold message 138, the cloud server 120 may delete the data snapshot 126.

The dispatch system 140 refers to one or more hardware devices configured to communicate with the vehicles 102, cloud server 120, occupant devices 128, and third-party requester devices 136 over the communication network 114. The dispatch system 140 may be a call center that receives calls for assistance and routes those calls to the appropriate services. The appropriate services may include police, ambulance, tire replacement courtesy vehicles, etc.

As the vehicle 102 may no longer be able to access the communications network 114 if the incident occurs, it may not be possible to rely on the vehicle 102 to automatically send the data snapshot 126 to the dispatch system 140. Yet, it may be undesirable for the vehicle 102 to send the data snapshot 126 to the dispatch system 140 based on the mere possibility of an incident that never occurs. To address this, the vehicle data service 134 may automatically forward the data snapshot 126 to the dispatch system 140 after a predefined period of time elapsed, but only if a cancel hold message 138 is not received from the vehicle 102 within that period of time. This allows the data snapshot 126 information, such as GNSS location, vehicle status, operation history, and occupant information, to be made available to the dispatch system 140, despite the vehicle 102 no longer being able to provide the data directly. If the cancel hold message 138 is received by the cloud server 120 before the predefined period of time has elapsed, the vehicle data service 134 may refrain from forwarding the data snapshot 126 to the dispatch system 140.

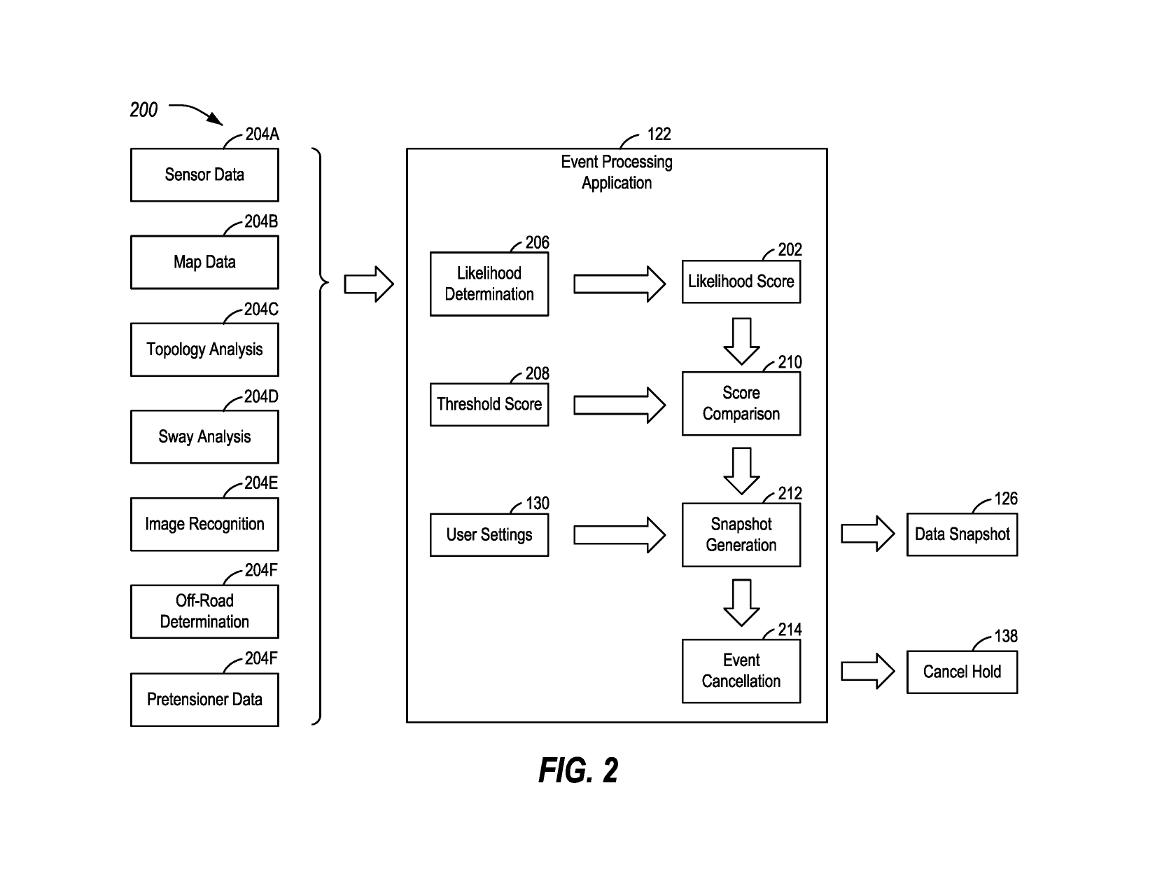

FIG. 2 illustrates a data flow 200 for assessing a likelihood score 202 indicative of a probability of occurrence of an incident. As shown, the event processing application 122 may receive various factors 204 as inputs. A likelihood determination 206 component of the event processing application 122 may utilize the factors 204 to determine the likelihood score 202. A score comparison 210 may be performed on the likelihood score 202 with a predefined threshold score 208. If the likelihood score 202 exceeds the predefined threshold score 208, a snapshot generation 212 is performed using the user settings 130 to generate the data snapshot 126 to be sent to the cloud server 120. If the incident does not occur, an event cancellation 214 component generates the cancel hold message 138 to be sent to the cloud server 120.

The likelihood score 202 refers to a relative likelihood that an incident may occur where generation of the data snapshot 126 is desired. In many examples, the likelihood score 202 is provided as a value along a scale, e.g., from 0 to 1, or from 0 to 100%.

The likelihood determination 206 function may determine the likelihood score 202 based on the various factors 204. These factors 204 may include, for example, sensor data 204A, map data 204B, a topology analysis 204C, a sway analysis 204D, image recognition 204E, an off-road determination 204F, and/or pretensioner data 204G. The factors 204 may be analyzed by the event processing application 122 to determine the likelihood score 202. For example, the event processing application 122 may utilize the last 30 seconds of the factors 204 of the vehicle 102 to determine an instant likelihood score 202.

The sensor data 204A may include data from the sensors 106 of the vehicle 102. In an example, these sensors 106 may include one or more of cameras (e.g., ADAS cameras), ultrasonic sensors, radar systems, and/or lidar systems.

The map data 204B may include information indicating whether the vehicle 102 is approaching or near a roadway edge, bridge, mountain, or drop-off. This data may be geofenced to provide alerts when the vehicle 102 enters a region close to such hazards. The event processing application 122 may use this geofenced information to assess the trajectory of the vehicle 102 and determine if there is a likelihood of exiting the roadway or encountering a fixed object.

The topology analysis 204C may assess changes in elevation, road curvature, or surrounding terrain. For instance, if the analysis detects sharp elevation changes, curves, or regions near a drop-off, the event processing application 122 may calculate a higher likelihood score 202 of an incident. Such analysis may also integrate data from suspension inputs or chassis movements to refine the evaluation.

The sway analysis 204D involves monitoring trailer sway and other oscillatory movements. For example, detection of large amplitude sway or erratic trailer movements may indicate a higher chance of an incident. The event processing application 122 may assess the extent of trailer sway to adjust the likelihood score 202 dynamically.

The image recognition 204E may process data from cameras to identify potential incidents with bridges, buildings, mountains, and drop-offs. By analyzing these features in real time, the event processing application 122 can determine if the vehicle 102 is on a trajectory likely to result in an incident. Various object detection algorithms may be employed to enhance detection accuracy and minimize false positives.

The off-road determination 204F evaluates whether the vehicle 102 has departed from the roadway. This determination may be based on several aspects, such as camera-based events (e.g., identifying lane departures), surface irregularities, or large suspension inputs indicating uneven terrain. Additionally, impacts in various directions may also inform the determination, signaling that the vehicle 102 may have entered off-road conditions.

The pretensioner data 204G may be used to predict occurrence of various events. For example, the pretensioner data 204G may indicate pre-tensioning mechanisms are triggered. This determination may involve evaluating trajectory estimates of the vehicle 102, including aspects such as distance apart from other vehicles 102, relative velocities, and current heading directions.

The likelihood determination 206 of the event processing application 122 may determine the likelihood score 202 using various techniques, including machine learning models trained on historical driving data, predefined rules or thresholds, and real-time sensor data 204A fusion. For instance, a neural network model may evaluate patterns in sensor 106 inputs to classify the likelihood of a collision or road departure. Additionally, heuristic approaches may be applied, such as using predefined thresholds for specific inputs (e.g., trailer sway amplitude or proximity to a road edge) to generate probability scores. These scores may then be aggregated into a composite likelihood score 202, representing the likelihood of an incident.

The score comparison 210 may receive the likelihood score 202 and may compare the likelihood score 202 with a predefined threshold score 208. The predefined threshold score 208 may be a minimum value along the scale of the likelihood score 202 such that if the likelihood score 202 is at least the predefined threshold score 208, the snapshot generation 212 is performed using the user settings 130 to generate the data snapshot 126.

The event cancellation 214 of the event processing application 122 may determine whether the data snapshot 126 is no longer required due to non-occurrence of the incident. This may be determined in various ways. For example, if the vehicle 102 remains operable without the occurrence of data indicative of an incident for at least a predefined period of time, then the event cancellation 214 may determine that the data snapshot 126 is no longer required. In another example, if the likelihood score 202 reduces to below the predefined threshold score 208, then the vehicle 102 may determine that no incident occurred or is likely to occur and therefore that the data snapshot 126 is no longer required. In such cases, the event cancellation 214 may generate the cancel hold message 138.

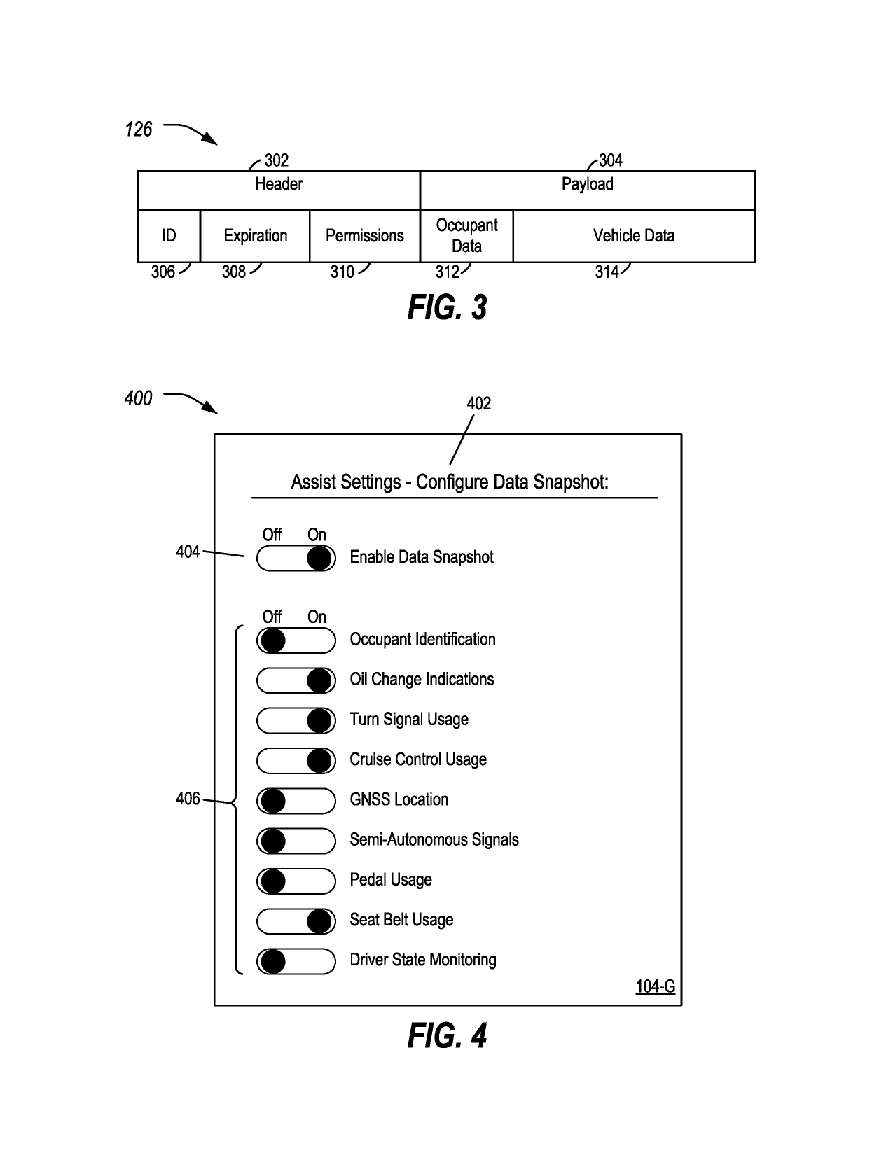

FIG. 3 illustrates an example of a data snapshot 126 generated based on the likelihood score 202. As shown, the data snapshot 126 includes a header 302 and a payload 304. The header 302 includes metadata such as an identifier 306 of the vehicle 102, expiration 308 of the data snapshot 126, and/or permissions 310 of the data snapshot 126. The payload 304 includes information such as occupant data 312 and vehicle data 314. The specific information that is included in the data snapshot 126 is as specified by the user settings 130, as noted above.

The identifier 306 may include information indicating the vehicle 102 that sent the data snapshot 126. In some examples, the identifier 306 may include a VIN, barcode, license plate number, etc. of the vehicle 102. For instance, as explained in detail below, the third-party requester device 136 may scan the identifier 306 from the vehicle 102 itself to be able to access the data snapshot 126.

The expiration 308 may include information indicative of the lifetime of the data snapshot 126. In an example, the expiration 308 may specify a date and/or time after which the data snapshot 126 should be deleted. In another example, the expiration 308 may specify a time-to-live of the data snapshot 126, after which the data snapshot 126 should be deleted. In either case, when the expiration 308 is reached the cloud server 120 may delete the data snapshot 126 from the database 132.

The permissions 310 may include information that specifies who may access the data snapshot 126. This may include, for example, whether or not the information may be accessible to the third-party requester devices 136. For instance, in one example, the permissions 310 may indicate that the occupant data 312 is accessible to all third-party requester devices 136, while in another example the permissions 310 may indicate that the occupant data 312 is only accessible to medical third-party requester devices 136.

The occupant data 312 may include information indicative of the occupants of the vehicle 102 that has been opted into being shared as specified by the user settings 130. This may include personally identifiable information (PII) such as name, address, age, etc. The occupant data 312 may also include other information about the occupants, such as weight, allergies, medications that the occupants are prescribed, etc.

The vehicle data 314 may include information indicative of the operation of the vehicle 102. This may include, for example, a snapshot of vehicle bus 108 data, media recorded by sensors 106 of the vehicle 102, etc. The vehicle data 314 may be useful in determining the cause of the incident that may have occurred with the vehicle 102. In some cases, the vehicle data 314 may include data for a trailing period of time up to the sending of the data snapshot 126, such as thirty seconds. In some cases, the time period for the determination of the likelihood score 202 and of the included vehicle data 314 are for the same time period.

FIG. 4 illustrates an example configuration screen 400 for the configuration of the user settings 130 for generation of the data snapshot 126. In an example, the configuration screen 400 may be provided by the HMI controller 104G to a display of the vehicle 102. In another example, the configuration screen 400 may be provided on a user interface of an occupant mobile device 128 in communication with the vehicle 102 to provide the user setting 130 to the vehicle 102.

In the example, the configuration screen 400 provides a title 402 indicating that the configuration screen 400 is for configuring the data snapshot 126. The configuration screen 400 includes an opt-in control 404 that, when set to yes allows for the data snapshot 126 functionality to be enabled. In an example, selection of yes may present terms of service and obtain user approval for participation in the system 100.

The configuration screen 400 also illustrates a set of signal controls 406 for occupant data 312 and/or vehicle data 314 that may be selected or deselected for inclusion in the data snapshot 126 by the vehicle data service 134 when the data snapshot 126 functionality is enabled. For example, the signal control 406 may include one or more of: a signal control 406 for selecting the use of the occupant data 312, a signal control 406 for selecting the use of an oil change indication, a signal control 406 for selecting the use of turn signal usage, a signal control 406 for selecting the use of cruise control, a signal control 406 for selecting the use of location signals indicative of the location of the vehicle 102, a signal control 406 for selecting the use of semi-autonomous driving signals, a signal control 406 for selecting the use of pedal usage signals, a signal control 406 for selecting the use of seat belt usage signals, and/or a signal control 406 for selecting the use of driver state monitoring signals. It should be noted that these are only examples, and more, fewer, and different signals and/or sets or categories of signals may be used with the signal controls 406.

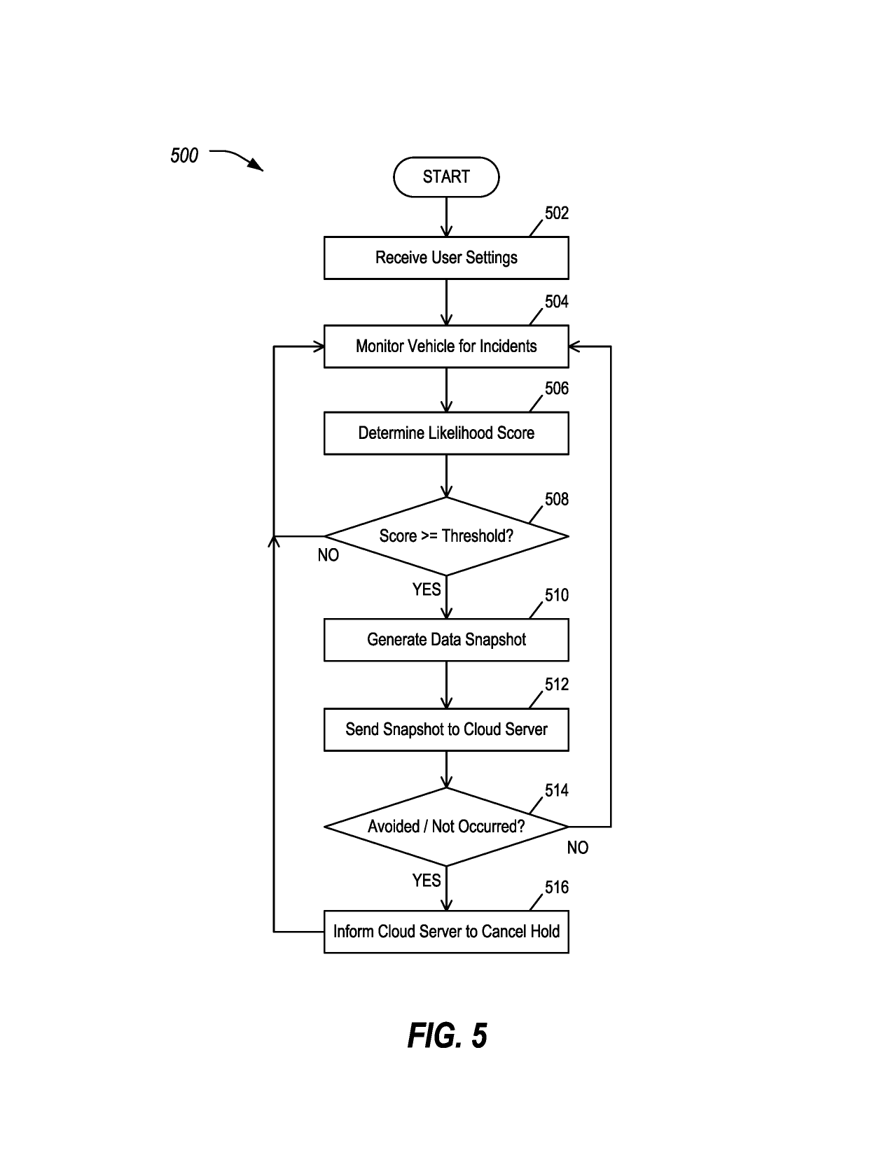

FIG. 5 illustrates an example process 500 for the generation of data snapshots 126 by the vehicle 102. In an example, the process 500 may be performed by the vehicle 102 in the context of the system 100 discussed in detail herein.

At operation 502, the vehicle 102 receives user settings 130 that configure the operation of the data snapshot 126 feature. In an example, the user may utilize a configuration screen 400 provided by the HMI controller 104G or an occupant mobile device 128 to opt into the data snapshot 126 functionality. The user settings 130 allow the user to expressly enable the feature and agree to terms of service if required. Additionally, the user settings 130 enable the user to configure the contents of the data snapshot 126, such as selecting specific occupant data 312 and/or vehicle data 314 to include. The user may also define permissions for accessing the data snapshot 126, specifying who may access the data, such as emergency responders or insurance providers.

At operation 504, the vehicle 102 monitors for potential incidents. This may include the event processing application 122 continuously analyzing inputs from various sources. The event processing application 122 may use real-time data from the sensors 106, including radar, lidar, ultrasonic systems, and cameras, to monitor environmental factors such as relative velocities, trajectories, and nearby objects. Additionally, the event processing application 122 may evaluate vehicle signals 124, such as throttle position, brake status, and steering angle, to assess the operational status of the vehicle 102. Other factors, such as map data 204B indicating roadway hazards, topology analysis 204C assessing road elevation changes, and external conditions such as weather, may also be considered during the monitoring process.

At operation 506, the event processing application 122 determines a likelihood score 202 indicative of the probability of an incident. This likelihood score 202 may be calculated using a combination of real-time sensor data 204A, historical driving data analyzed by machine learning models, and predefined thresholds for specific parameters. For example, the application may integrate patterns from sensor 106 inputs and environmental data to predict potential incidents such as a collision or road departure. The calculated likelihood score 202 reflects the relative probability of an incident occurring within a specific timeframe.

At operation 508, the vehicle 102 determines whether the likelihood score 202 is at least the predefined threshold score 208. If the likelihood score 202 meets or exceeds the predefined threshold score 208, control proceeds to operation 510. If the likelihood score 202 is below the threshold, the vehicle 102 continues monitoring for incidents at operation 504. Thus, the predefined threshold score 208 serves as a trigger point to initiate further steps in response to an elevated likelihood of an incident.

At operation 510, the vehicle 102 generates the data snapshot 126. In an example, the snapshot generation 212 of the event processing application 122 compiles the data snapshot 126 based on the user settings 130. The data snapshot 126 may include vehicle data 314 such as GNSS location data and vehicle status information, as well as occupant data 312 if enabled by the user. The contents of the data snapshot 126 may also be encrypted to ensure secure transmission and storage.

At operation 512, the vehicle 102 transmits the data snapshot 126 to the cloud server 120. The transmission may be performed using the TCU 110 over the communication network 114. If the TCU 110 is unable to access the communication network 114, the occupant mobile device 128 may serve as a fallback mechanism to send the data snapshot 126. This ensures that the data is transmitted to the cloud server 120 regardless of the connectivity status of the vehicle 102.

At operation 514, the vehicle 102 determines whether the likely incident does not occur or is avoided. This may be determined in various ways. For example, if the vehicle 102 remains operable without the occurrence of data indicative of an incident, and/or the likelihood score 202 reduces below the predefined threshold score 208, then the vehicle 102 may determine that no incident occurred or is likely to occur. If so, control proceeds to operation 516. If not, control returns to operation 504.

At operation 516, the vehicle 102 sends a cancel hold message 138 to the cloud server 120 to delete the data snapshot 126. This may allow for the cloud server 120 to delete the data snapshot 126 before the expiration 308 of the data snapshot 126 and/or refrain from sending the data snapshot 126 to the dispatch system 140. Following this operation, control returns to operation 504, allowing the vehicle 102 to continue monitoring for new potential incidents.

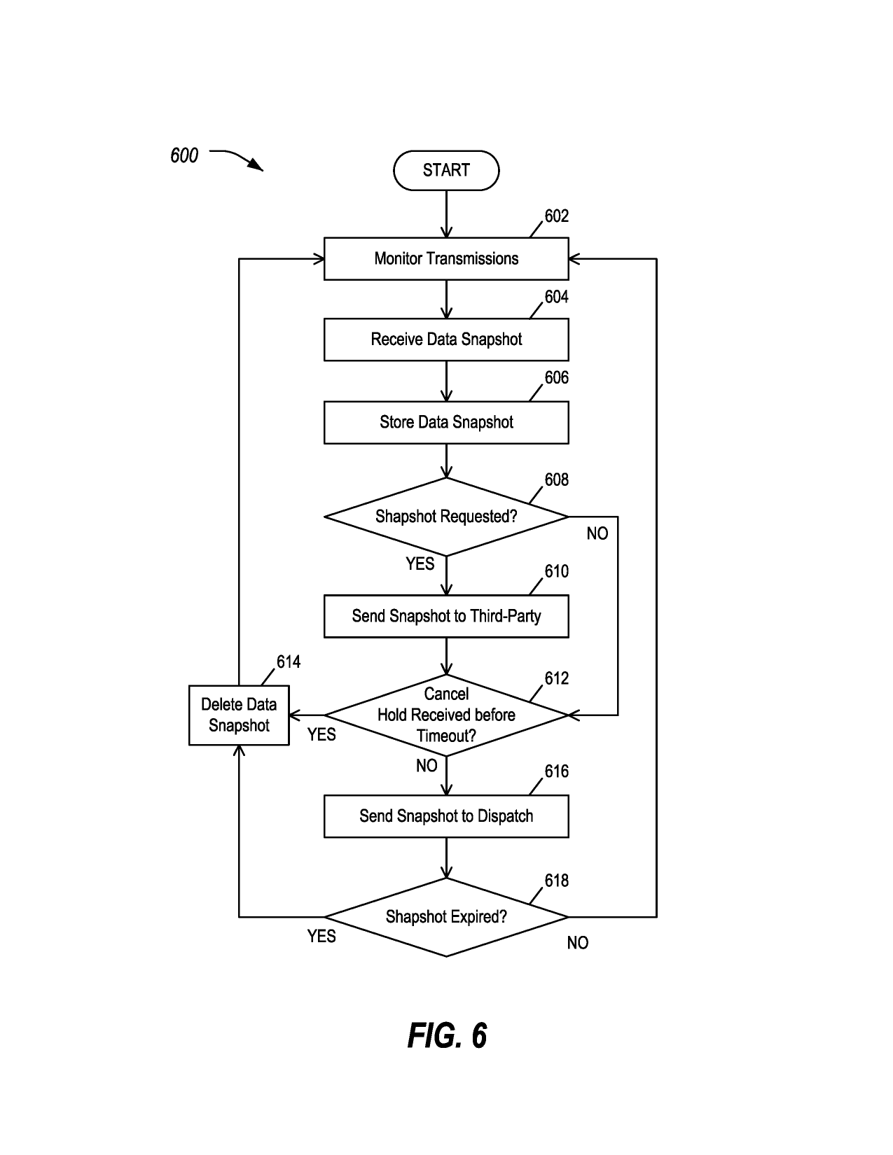

FIG. 6 illustrates an example process 600 for the receipt, distribution, and deletion of data snapshots 126 by cloud server 120. In an example, the process 600 may be performed by the vehicle data service 134 of the cloud server 120 in the context of the system 100 discussed in detail herein.

At operation 602, the cloud server 120 monitors for transmissions. In an example, the vehicle data service 134 may listen for data snapshots 126 from vehicles 102. In another example, the vehicle data service 134 may listen for third-party requester device 136 making requests for the data snapshot 126. In yet another example, the vehicle data service 134 may listen for messages from vehicles 102 indicating that the data snapshot 126 is not required to be maintained.

At operation 604, the cloud server 120 receives a data snapshot 126. In an example, the vehicle data service 134 may process incoming encrypted transmissions from vehicles 102 or occupant mobile devices 128 over the communication network 114. The data snapshot 126 may be decrypted upon receipt and/or verified for authenticity using cryptographic signatures to ensure that the data snapshot 126 has not been tampered with or corrupted during transmission. Additionally, the vehicle data service 134 may validate the metadata in the header 302, such as ensuring the automatic expiration 308 timing and ensuring that the permissions 310 allow for the data snapshot 126 to be used.

At operation 606, the cloud server 120 stores the data snapshot 126 in the database 132. In an example, the vehicle data service 134 may organize the snapshot using indexing based on one or more unique identifiers associated with the vehicle 102 (e.g., VIN, a barcode, the license plate of the vehicle) that may be scanned by third-party requester devices 136 to retrieve the data snapshot 126.

At operation 608, the cloud server 120 determines whether the data snapshot 126 is requested. In an example, the vehicle data service 134 monitors for incoming requests from third-party requester devices 136 as noted at operation 602. Each request may include one or more unique identifiers associated with the vehicle 102 for which the data snapshot 126 is being requested. The request may be validated against the permissions 310 defined for the data snapshot 126 to confirm that the third-party requester device 136 is authorized to access the data. If a valid request is identified, control proceeds to operation 610. If not, control proceeds to operation 612.

At operation 610, the cloud server 120 sends the data snapshot 126 to the third-party requester device 136. In an example, the vehicle data service 134 may encrypts the snapshot before transmission to ensure secure delivery. Delivery protocols may vary based on the recipient’s capabilities and preferences, such as using secure application program interface (API) calls, email with attachments, or direct file transfer over an encrypted channel. In some examples, a receipt confirmation may be employed and sent from the third-party requester device 136 to the vehicle data service 134 to verify successful delivery, and in some cases the database 132 may be updated to log the transaction details, including timestamp, recipient identifier, and the type of data accessed. After operation 610, control returns to operation 602.

At operation 612, the cloud server 120 determines whether a cancel hold message 138 has been received within a predefined timeout period. The predefined timeout period may be measured from receipt of the data snapshot 126 and/or from a timestamp included in the data snapshot 126, but other values or approaches may be used. In an example, the cancel hold message 138 may have been sent by the vehicle 102 as discussed with respect to operation 516. In such a case, the vehicle data service 134 may determine to delete the data snapshot 126 before the expiration 308 of the data snapshot 126 and/or refrain from sending the data snapshot 126 to the dispatch system 140. To do so, control proceeds to operation 614. If not, control proceeds to operation 616 to send the data snapshot 126 to the dispatch server 140.

At operation 614, the cloud server 120 deletes the data snapshot 126. In an example, the vehicle data service 134 removes the data snapshot 126 from the database 132. Secure deletion protocols, such as overwriting or shredding the data, may be employed to ensure that the data snapshot 126 cannot be recovered after deletion. Following the deletion, the data snapshot 126 may update its logs in the database 132 to reflect the operation, recording details such as the deletion timestamp and the reason for deletion (e.g., expiration or a user-initiated deletion request). After operation 614, control proceeds to operation 602.

At operation 616, the cloud server 120 sends the data snapshot 126 to the dispatch server 140. The send operation may be performed similar to as discussed above with respect to operation 610, except the destination is the dispatch server 140 rather than the third-party requester device 136. After operation 616, control proceeds to operation 618.

At operation 618, the cloud server 120 determines whether the data snapshot 126 has expired. In an example, the vehicle data service 134 may utilize the expiration 308 metadata associated with the data snapshot 126 to check the current timestamp against the data snapshot 126 time or conditions specified by the expiration 308. If the data snapshot 126 has expired, the vehicle data service 134 marks it for deletion from the database 132. If the data snapshot 126 has not yet expired, the data snapshot 126 remains accessible in the database 132, subject to any additional requests or updates. In some examples, a user-initiated deletion request may have been received, which would trigger expiration of the data snapshot 126 regardless of timing. If the data snapshot 126 has expired, control proceeds to operation 614. Otherwise, control returns to operation 602.

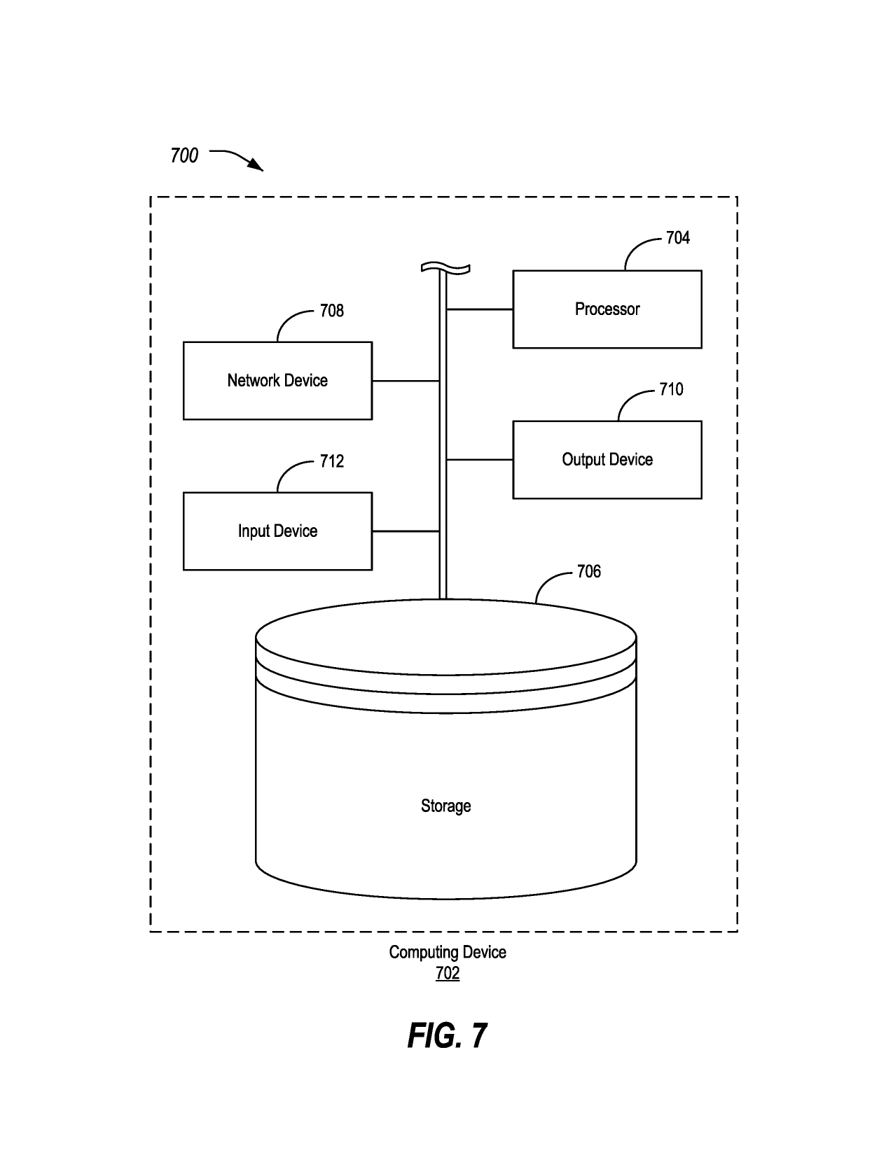

Variations on the process 600 are possible. In an example, the cloud server 120 may additionally or alternately confirm that the data snapshot 126 should be sent to the dispatch system 140 by sending a confirmation message to the occupant device(s) 128 and/or to other mobile devices that are associated with an owner/operator of the vehicle 102. This may be done to provide an additional level of security to the data included in the data snapshot 126.FIG. 7 illustrates an example computing device 702 for use in sending a pre-incident data snapshot 126 from the vehicle 102. Referring to FIG. 7, and with reference to FIGS. 1-6, the vehicle 102, controllers 104, sensors 106, TCU 110, and cloud server 120 may be examples of such computing devices 702. Computing devices 702 generally include computer-executable instructions, such as those of the vehicle data service 134 and the event processing application 122, where the instructions may be executable by one or more computing devices 702. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as vehicle signals 124, data snapshots 126, user settings 130, the vehicle data service 134, likelihood scores 202, factors 204, likelihood determinations 206, predefined threshold scores 208, score comparisons 210, snapshot generations 212, etc., may be stored and transmitted using a variety of computer-readable media.

As shown, the computing device 702 may include a processor 704 that is operatively connected to a storage 706, a network device 708, an output device 710, and an input device 712. It should be noted that this is merely an example, and computing devices 702 with more, fewer, or different components may be used.

The processor 704 may include one or more integrated circuits that implement the functionality of a central processing unit (CPU) and/or graphics processing unit (GPU). In some examples, the processors 704 are a system on a chip (SoC) that integrates the functionality of the CPU and GPU. The SoC may optionally include other components such as, for example, the storage 706 and the network device 708 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 704 executes stored program instructions that are retrieved from the storage 706. The stored program instructions, accordingly, include software that controls the operation of the processors 704 to perform the operations described herein. The storage 706 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 710. The output device 710 may include a graphical or visual display device, such as an electronic display screen, projector, printer, or any other suitable device that reproduces a graphical display. As another example, the output device 710 may include an audio device, such as a loudspeaker or headphone. As yet a further example, the output device 710 may include a tactile device, such as a mechanically raiseable device that may, in an example, be configured to display braille or another physical output that may be touched to provide information to a user.

The input device 712 may include any of various devices that enable the computing device 702 to receive control input from users. Examples of suitable input devices 712 that receive human interface inputs may include keyboards, mice, trackballs, touchscreens, microphones, graphics tablets, and the like.

The network devices 708 may each include any of various devices that enable the described components to send and/or receive data from external devices over networks. Examples of suitable network devices 708 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments may occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for sending vehicle data, comprising:
determining, by a vehicle, a likelihood score indicative of a probability of an incident based on real-time sensor data;
responsive to the likelihood score meeting a predefined threshold, generating a data snapshot comprising vehicle data, global navigation satellite system (GNSS) location data, and occupant information, wherein the data snapshot defines an expiration after which the data snapshot is to be automatically deleted; and
transmitting the data snapshot to a cloud server for temporary storage at the cloud server and automatic deletion based on the expiration.

2. The method of claim 1, further comprising, responsive to determining that the incident does not occur, sending a cancel hold message to the cloud server to cause the cloud server to refrain from forwarding the data snapshot to a dispatch service and delete the data snapshot before the expiration.

3. The method of claim 1, wherein the data snapshot is sent to the cloud server (i) via a telematics control unit (TCU) of the vehicle over a communication network or (ii) via an occupant mobile device responsive to the TCU being unable to access the communication network.

4. The method of claim 1, wherein the data snapshot further comprises permissions specifying access restrictions for third-party requester devices to the data snapshot.

5. The method of claim 1, further comprising:
utilizing a human-machine interface (HMI) of the vehicle to present a configuration interface for users to opt into enabling generation of the data snapshot and for the users to define which elements of vehicle data and occupant information to be included in the snapshot; and
updating user settings for generation of the data snapshot responsive to user input to the HMI.

6. The method of claim 1, wherein determining the likelihood score includes:
analyzing the sensor data, from radio detection and ranging (RADAR), light detection and ranging (LIDAR), ultrasonic systems, and/or cameras of the vehicle;
integrating map data indicating roadway hazards or geographic features; and
applying a machine learning model trained on the sensor data to assess the probability of the incident.

7. The method of claim 1, wherein the expiration specifies one of:
a date and/or time after which the data snapshot is deleted, or
a time-to-live of the data snapshot after which the data snapshot is deleted.

8. A vehicle for sending vehicle data, comprising:
sensors; and
one or more controllers configured to:
determine, by a vehicle, a likelihood score indicative of a probability of an incident based on real-time sensor data,
responsive to the likelihood score meeting a predefined threshold, generate a data snapshot comprising one or more of GNSS location data, occupant information, and vehicle data captured by the sensors, wherein the data snapshot defines an expiration after which the data snapshot is to be automatically deleted, and
transmit the data snapshot to a cloud server for temporary storage at the cloud server and automatic deletion based on the expiration.

9. The vehicle of claim 8, wherein the one or more controllers are further configured to, responsive to determining that the incident does not occur, send a cancel hold message to the cloud server to cause the cloud server to refrain from forwarding the data snapshot to a dispatch service and delete the data snapshot before the expiration.

10. The vehicle of claim 8, wherein the one or more controllers are further configured to send the data snapshot to the cloud server (i) via a TCU of the vehicle over a communication network or (ii) via an occupant mobile device responsive to the TCU being unable to access the communication network.

11. The vehicle of claim 8, wherein the data snapshot further comprises permissions specifying access restrictions for third-party requester devices to the data snapshot.

12. The vehicle of claim 8, wherein the one or more controllers are further configured to:
utilize a HMI of the vehicle to present a configuration interface for users to opt into enabling generation of the data snapshot and for the users to define which elements of vehicle data and occupant information to be included in the snapshot; and
update user settings for generation of the data snapshot responsive to user input to the HMI.

13. The vehicle of claim 8, wherein the one or more controllers are further configured to determine the likelihood score using operations including to:
analyze the sensor data, from RADAR, LIDAR, ultrasonic systems, and/or cameras of the vehicle;
integrate map data indicating roadway hazards or geographic features; and
apply a machine learning model trained on the sensor data to assess the probability of the incident.

14. The vehicle of claim 8, wherein the expiration specifies one of:
a date and/or time after which the data snapshot is deleted, or
a time-to-live of the data snapshot after which the data snapshot is deleted.

15. A cloud server for managing data snapshots, comprising:
a database; and
one or more computing devices configured to:
receive a data snapshot transmitted from a vehicle or an occupant mobile device over a communication network, wherein the data snapshot includes vehicle data from sensors of the vehicle, wherein the data snapshot defines an expiration after which the data snapshot is to be automatically deleted and a unique identifier of the vehicle,
store the data snapshot in the database, indexed by the unique identifier,
responsive to receiving a request from a third-party requester device, validate the request against access permissions associated with the data snapshot and transmit the data snapshot to the third-party requester device if the request is authorized,
responsive to lack of receipt of a cancel hold message from the vehicle within a predefined period of time within the expiration, automatically forward the data snapshot to a dispatch service, and
automatically delete the data snapshot from the database based on the expiration.

16. The cloud server of claim 15, wherein the one or more computing devices are further configured to automatically delete the data snapshot from the database responsive to receipt of the cancel hold message from the vehicle.

17. The cloud server of claim 15, wherein the unique identifier includes one or more of a vehicle identification number (VIN), a barcode, or a license plate number.

18. The cloud server of claim 15, wherein the data snapshot further includes GNSS location data indicative of a history of locations of the vehicle.

19. The cloud server of claim 15, wherein the data snapshot further includes occupant information indicative of identifies of one or more occupants of the vehicle.

20. The cloud server of claim 15, wherein the expiration specifies one of:
a date and/or time after which the data snapshot is deleted, or
a time-to-live of the data snapshot after which the data snapshot is deleted.
